(19) United States
(12) Patent Application Publication
(10) Pub. No.: US 2026/0285691 A1
(43) Pub. Date: Sep. 24, 2026

(54) METHOD FOR PREPARING SILICON CARBIDE (SiC) NANOMATERIAL USING SOLID WASTE

(71) Applicant: Yan'an University, Yan'an City (CN)

(72) Inventors: Zhuangzhuang ZHANG, Yan'an City (CN); Kaixing GAO, Yan'an City (CN); Yao ZHANG, Yan'an City (CN); Maomao NIU, Yan'an City (CN); Feng FU, Yan'an City (CN); Yanzhong ZHEN, Yan'an City (CN); Xiaoxia YANG, Yan'an City (CN); Jie GU, Yan'an City (CN)

(73) Assignee: Yan'an University, Yan'an City (CN)

(21) Appl. No.: 19/252,426

(22) Filed: Jun. 27, 2025

(30) Foreign Application Priority Data
Mar. 24, 2025 (CN) 202510349474.5

(51) Int. Cl. C01B 32/963

(52) U.S. Cl. CPC C01B 32/963; C01P 2002/72; C01P 2002/82; C01P 2002/84; C01P 2004/03; C01P 2004/04

(57) ABSTRACT

A method for preparing a silicon carbide (SiC) nanomaterial using a solid waste is provided. The method includes the following steps: subjecting coal gangue to activation and acid leaching in sequence to obtain a coal gangue silicon slag; and mixing the coal gangue silicon slag and a high-carbon solid waste, and subjecting a resulting mixture to carbothermal reduction, and then subjecting a resulting reduction product to roasting and acid pickling in sequence to obtain the SiC nanomaterial; wherein the high-carbon solid waste has a carbon content of 70 wt % to 80 wt %; the coal gangue has a purity of not less than 95%; and the SiC nanomaterial has a bandgap of not less than 2.45 eV, a specific capacity of not less than 270 mAh/g, and a resistivity of not less than 1,190 Ω·cm.

### CROSS REFERENCE TO RELATED APPLICATION

This patent application claims the benefit and priority of Chinese Patent Application No. 202510349474.5 filed with the China National Intellectual Property Administration on Mar. 24, 2025, the disclosure of which is incorporated by reference herein in its entirety as part of the present application.

### TECHNICAL FIELD

The present disclosure provides a method for preparing a silicon carbide (SiC) nanomaterial using a solid waste, belonging to the technical field of the preparation of nanomaterials.

### BACKGROUND

SiC exhibits excellent chemical stability, high thermal conductivity, and strong oxidation resistance, with hardness second only to diamond and cubic boron nitride. SiC is widely used in advanced refractory materials, abrasives, and precision ceramics. Furthermore, SiC is recognized as a third-generation semiconductor material due to its wider bandgap, higher breakdown electric field, superior thermal conductivity, and elevated electron saturation velocity, making it ideal for high-temperature, high-frequency, radiation-resistant, and high-power devices. These properties have established SiC as one of the most prominent materials in the field of advanced materials.

Conventional industrial synthesis of SiC relies on the Acheson process, where high-purity quartz sand (≥99%) and petroleum coke (≥98%) are processed in a high-temperature resistance furnace. This approach imposes stringent purity requirements on raw materials, resulting in high production costs, limited performance, and restricted application scenarios for the synthesized SiC.

### SUMMARY

An object of the present disclosure is to provide a method for preparing an SiC nanomaterial using a solid waste. In the present disclosure, the method does not require high-purity raw materials, has low preparation costs, and achieves a product with better performance.

To achieve the above object, the present disclosure provides the following technical solutions:

The present disclosure provides a method for preparing an SiC nanomaterial using a solid waste, including the following steps:
(1) subjecting coal gangue to activation and acid leaching in sequence to obtain a coal gangue silicon slag; and
(2) mixing the coal gangue silicon slag and a high-carbon solid waste, and subjecting a resulting mixture to carbothermal reduction, and then subjecting a resulting reduction product to roasting and acid pickling in sequence to obtain the SiC nanomaterial; where the high-carbon solid waste has a carbon content of 70 wt % to 80 wt %; the coal gangue has a purity of not less than 95%; and the SiC nanomaterial has a bandgap of not less than 2.45 eV, a specific capacity of not less than 270 mAh/g, and a resistivity of not less than 1,190 Ω·cm.

In some embodiments, the carbothermal reduction is conducted in a protective atmosphere; the carbothermal reduction includes a heating stage and a holding stage; in the heating stage, a heating rate is 5° C./min to 10° C./min; and in the holding stage, a temperature of 1,300° C. to 1,600° C. is held for 1 h to 5 h.

In some embodiments, the roasting is conducted at a temperature of 500° C. to 1,000° C. for 1 h to 4 h.

In some embodiments, the activation is conducted at a temperature of 500° C. to 1,000° C. for 60 min to 240 min.

In some embodiments, the method further comprises heating the coal gangue before the activation; and the heating is conducted at a heating rate of 5° C./min to 10° C./min.

In some embodiments, the acid leaching is conducted in an acid solution at a temperature of 80° C. to 150° C. for 1 h to 24 h; the acid leaching is conducted under stirring; and a ratio of a volume of the acid solution to a mass of the coal gangue is in a range of 1 mL: 1 g to 10 mL: 1 g.

In some embodiments, the high-carbon solid waste is one or more selected from the group consisting of a coal-oil co-processing residue and a pyrolyzed and carbonized waste tire.

In some embodiments, the pyrolyzed and carbonized waste tire is prepared by a process including subjecting a waste tire to pyrolysis and carbonization at a temperature of 500° C. to 700° C.

In some embodiments, a molar ratio of carbon in the high-carbon solid waste to silicon in the coal gangue silicon slag is in a range of 2:1 to 4:1.

In some embodiments, the mixing of the coal gangue silicon slag and the high-carbon solid waste is conducted by ball milling mixing, and the ball milling mixing is conducted at a rotational speed of 60% to 80% for 1 min to 5 min.

The present disclosure provides a method for preparing an SiC nanomaterial using a solid waste. In the present disclosure, the coal gangue is used as a silicon source and the high-carbon solid waste (with carbon content not less than 70 wt %) is used as a carbon source, resulting in that the method achieves low-cost synthesis of the SiC nanomaterial through tailored stepwise extraction and utilization based on the compositional characteristics of different solid wastes, without requiring high-purity raw materials. The SiC nanomaterial exhibits enhanced properties, including a wider bandgap, superior specific capacity, and higher resistivity. These enhanced properties enable a broad application potential of the nanomaterial in cutting-edge fields such as third-generation semiconductors, defense and military industries, 5G communications, new energy vehicles, smart grids, and high-temperature devices.

In the present disclosure, the acid pickling is conducted to further remove impurities such as SiO₂ remaining in the SiC, thus finally obtaining the SiC nanomaterial with high purity. The preparation of SiC nanomaterial is achieved by controlling the nucleation and growth of SiC. In a reactive Si—O—C system, nano-scale SiC nuclei are formed through two distinct mechanisms. Specifically, heterogeneous gas-solid reaction includes SiO vapor reacting with solid carbon to generate SiC nuclei, which promotes the growth of nanoblock/nanosheet SiC; while homogeneous gas-gas reaction includes SiO reacting with CO gas to produce SiC nuclei, driving the growth of SiC nanowires.

The method achieves complementary high-value utilization of solid wastes such as coal gangue and high-carbon solid waste, significantly reducing the production cost of SiC, reducing the overall cost by 50% to 70%, and addressing the environmental and safety challenges caused by solid waste disposal. Moreover, the SiC nanomaterial with high purity (>98.9%) and nano-scale dimension (<100 nm) is successfully synthesized, demonstrating broad application prospects in advanced industrial fields. Compared to conventionally produced SiC materials, the SiC nanomaterial synthesized according to the present disclosure could exhibit a significantly reduced thickness (≤100 nm) and a unique nanofiber-like morphology. This structural design not only endows the material with a higher specific surface area but also exhibits superior multifunctional characteristics such as optical properties, electron transport efficiency, and energy storage performance.

### BRIEF DESCRIPTION OF THE DRAWINGS

To describe the technical solutions in embodiments of the present disclosure or in the prior art more clearly, the accompanying drawings required in embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1A shows a hard carbon nanosphere porous carbon material derived from waste tire carbonization; and FIG. 1B shows a cross-linked macromolecular lamellar stacking structure of coal-oil co-processing residue;

FIG. 2 shows an X-ray diffraction (XRD) pattern of the SiC nanomaterial prepared from the coal gangue and high-carbon solid waste;

FIG. 3A to FIG. 3D show SiC nanowires prepared using waste tires as a carbon source; and FIG. 3E to FIG. 3H show SiC nanosheets prepared using coal-oil co-processing residue as a carbon source;

FIG. 4A shows an XRD pattern of the SiC nanomaterial synthesized from the coal gangue and coal-oil co-processing residue; and FIG. 4B shows a Fourier transform infrared spectroscopy (FT-IR) spectrum of the SiC nanomaterial synthesized from the coal gangue and coal-oil co-processing residue;

FIG. 5A shows a scanning electron microscopy (SEM) image of the SiC nanomaterial prepared from the coal gangue and coal-oil co-processing residue; and FIG. 5B shows a transmission electron microscopy (TEM) image of the SiC nanomaterial prepared from the coal gangue and coal-oil co-processing residue;

FIG. 6A shows a XRD pattern of the SiC nanomaterial synthesized from the coal gangue and waste tire; and FIG. 6B shows an FT-IR spectrum of the SiC nanomaterial synthesized from the coal gangue and waste tire;

FIG. 7A shows an SEM image of the SiC nanomaterial prepared from the coal gangue and coal-oil co-processing residue; and FIG. 7B shows a TEM image of the SiC nanomaterial prepared from the coal gangue and coal-oil co-processing residue;

FIG. 8A shows an XRD pattern of the SiC nanomaterial synthesized from the coal gangue and waste tire; and FIG. 8B shows an FT-IR spectrum of the SiC nanomaterial synthesized from the coal gangue and waste tire;

FIG. 9A shows an SEM image of the SiC nanomaterial prepared from the coal gangue and waste tire; and FIG. 9B shows a TEM image of the SiC nanomaterial prepared from the coal gangue and waste tire;

FIG. 10A shows an XRD pattern of the SiC nanomaterial synthesized from the coal gangue and waste tire; and FIG. 10B shows an FT-IR spectrum of the SiC nanomaterial synthesized from the coal gangue and waste tire;

FIG. 11A shows an SEM image of the SiC nanomaterial prepared from the coal gangue and waste tire; and FIG. 11B shows a TEM image of the SiC nanomaterial prepared from the coal gangue and waste tire;

FIG. 12A shows an XRD pattern of the SiC material synthesized from the petroleum coke and quartz sand; and FIG. 12B shows an FT-IR spectrum of the SiC material synthesized from the petroleum coke and quartz sand;

FIG. 13 shows an SEM image of the SiC material prepared from the petroleum coke and quartz sand;

FIG. 14A shows an Ultraviolet-Visible Diffuse Reflectance Spectroscopy (UV-Vis DRS) spectrum of the SiC nanomaterial synthesized from the coal-oil co-processing residue and coal gangue in Example 1; and FIG. 14B shows a bandgap plot of the SiC nanomaterial synthesized from the coal-oil co-processing residue and coal gangue in Example 1;

FIG. 15A shows a UV-Vis DRS spectrum of the SiC nanomaterial synthesized from the waste tire and coal gangue in Example 3; and FIG. 15B shows a bandgap plot of the SiC nanomaterial synthesized from the waste tire and coal gangue in Example 3; and

FIG. 16A shows a UV-Vis DRS spectrum of the commercial-grade SiC in Comparative Example 1; and FIG. 16B shows a bandgap plot of the commercial-grade SiC in Comparative Example 1.

### DETAILED DESCRIPTION OF THE EMBODIMENTS

The present disclosure provides a method for preparing an SiC nanomaterial using a solid waste, including the following steps:
(1) subjecting coal gangue to activation and acid leaching in sequence to obtain a coal gangue silicon slag; and
(2) mixing the coal gangue silicon slag and a high-carbon solid waste, and subjecting a resulting mixture to carbothermal reduction, and then subjecting a resulting reduction product to roasting and acid pickling in sequence to obtain the SiC nanomaterial; where the high-carbon solid waste has a carbon content of 70 wt % to 80 wt %; the coal gangue has a purity of not less than 95%; and the SiC nanomaterial has a bandgap of not less than 2.45 eV, a specific capacity of not less than 270 mAh/g, and a resistivity of not less than 1,190 Ω·cm.

In the present disclosure, coal gangue is subjected to activation and acid leaching in sequence to obtain the coal gangue silicon slag. The coal gangue could be subjected to crushing, ball-milling, and sieving in sequence before use.

In the present disclosure, the coal gangue may have a particle size not greater than 0.2 mm, specifically 0.2 mm, 0.17 mm, 0.15 mm, 0.12 mm, 0.1 mm, 0.07 mm, 0.05 mm, or 0.01 mm.

In the present disclosure, the activation may be conducted at a temperature of 500° C. to 1,000° C., specifically 600° C. or 800° C., and the activation may be conducted for 60 min to 240 min, specifically 120 min or 180 min.

In the present disclosure, the method may further include heating before the activation; the heating may have a heating rate of 5° C./min to 10° C./min, specifically 7° C./min or 9° C./min.

In the present disclosure, the acid leaching may be conducted in an acid solution at a temperature of 80° C. to 150° C., specifically 120° C. for 1 h to 24 h, specifically 6 h, 12 h, or 18 h. Metal impurities such as aluminum and iron are leached out through the acid leaching.

In the present disclosure, an acid for the acid leaching may be an inorganic acid; the inorganic acid may include one or two of HCl and HNO₃.

In the present disclosure, the acid leaching may be conducted under stirring; a stirring rate may be 60% to 80% (the proportion of a rated speed, where the rated speed is 600 r/min), specifically 65% or 80%.

In the present disclosure, a mass ratio of the acid solution to the coal gangue is in a range of (1-10) mL: 1 g, specifically 3 mL: 1 g, 5 mL: 1 g, 7 mL: 1 g, or 9 mL: 1 g.

In the present disclosure, the method may further include after the acid leaching is completed, subjecting an obtained acid leaching system to solid-liquid separation, washing, and drying in sequence.

In the present disclosure, the solid-liquid separation may be centrifugation; the centrifugation may be conducted at a speed of 3,500 r/min to 8,500 r/min, specifically 4,000 r/min, 5,000 r/min, 6,000 r/min, 7,000 r/min, or 8,000 r/min, and the centrifugation may be conducted for 1 min to 10 min, specifically 3 min, 5 min, 7 min, or 9 min.

In the present disclosure, a reagent for the washing may include one or more selected from the group consisting of hydrochloric acid, nitric acid, and hydrofluoric acid; the washing may be conducted not less than 3 times, specifically 3 times, 5 times, or 7 times, until an obtained washing solution becomes neutral.

In the present disclosure, the drying may be conducted at a temperature of 70° C. to 100° C., specifically 85° C. or 90° C. In the present disclosure, the drying may be conducted for 1 h to 24 h, specifically 5 h, 12 h or 18 h.

In the present disclosure, the coal gangue silicon slag is obtained through the above treatment, where a neutral silicon oxide content is greater than 95%, and a specific composition is shown in Table 1.

TABLE 1
Chemical composition of coal gangue silicon slag
Chemical composition analysis/wt %

| SiO₂ | Al₂O₃ | Fe₂O₃ | K₂O | CaO | MgO | Na₂O |
|---|---|---|---|---|---|---|
| 95.53 | 2.62 | 0.13 | 0.40 | 0.031 | 0.039 | 0.16 |

In the present disclosure, the coal gangue silicon slag and a high-carbon solid waste are mixed (referred to as a first mixing), a resulting mixture is subjected to carbothermal reduction, and then to roasting and acid pickling in sequence to obtain the SiC nanomaterial. The high-carbon solid waste may be one or more selected from the group consisting of a coal-oil co-processing residue and a pyrolyzed and carbonized waste tire. Specific compositions of the coal-oil co-processing residue and waste tire used in the examples are shown in Table 2.

TABLE 2
Industrial analysis and elemental
analysis of high-carbon solid waste

| Solid waste name | Industrial analysis/% | | | | |
|---|---|---|---|---|---|
| Waste tire | M_{ad} | A_{ad} | | V_{ad} | FC_{ad} |
| | 0.705 | 18.69 | | 1.765 | 78.84 |
| | Elemental analysis/% | | | | |
| | C | H | O | N | S |
| | 78.44 | 0.437 | 4.351 | 0.39 | 3.51 |
| Coal-oil | Industrial analysis/% | | | | |
| co-processing | M_{ad} | A_{ad} | | V_{ad} | FC_{ad} |
| residue | 0.36 | 16.41 | | 47.36 | 35.87 |
| | Elemental analysis/% | | | | |
| | C | H | O | N | S |
| | 76.65 | 4.973 | 4.319 | 0.7 | 1.662 |

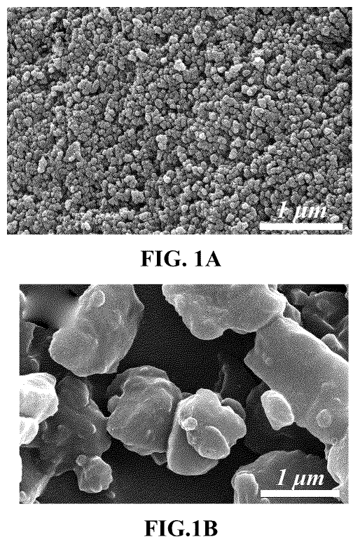

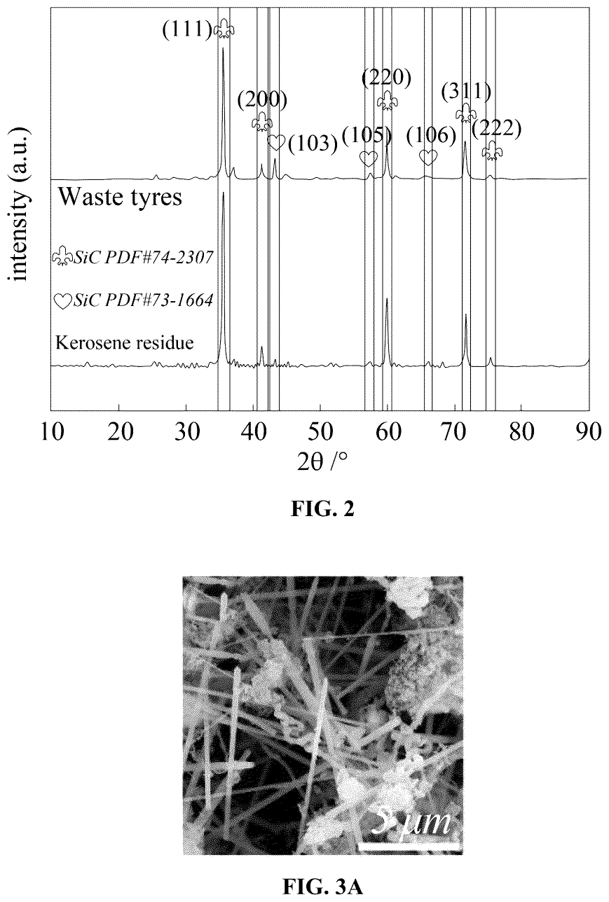

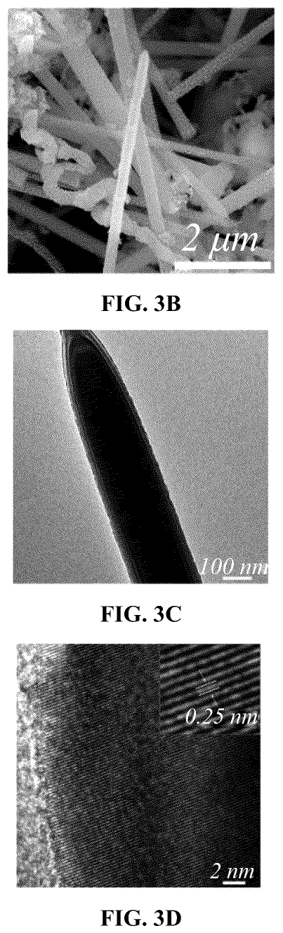

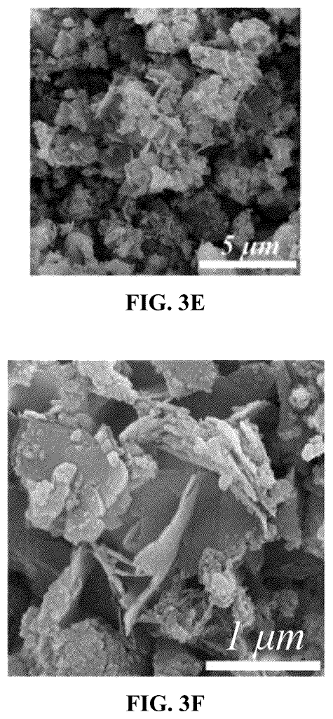

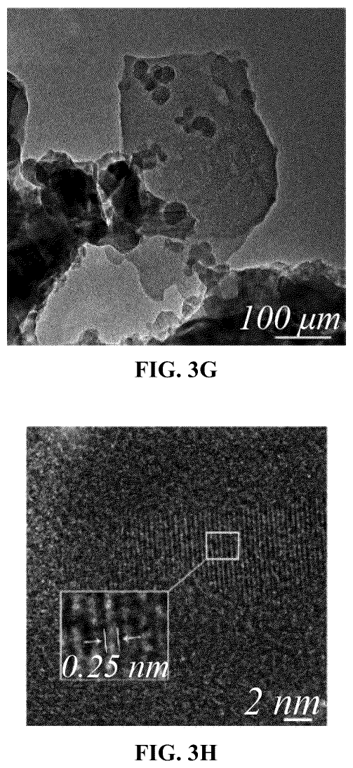

In the present disclosure, the method could controllably synthesize SiC nanomaterials with different morphologies. SiC nanomaterials (nanowires, nanosheets/blocks) with different morphologies could be controllably synthesized based on the differences in residual carbon forms in different high-carbon solid wastes. The residual carbon morphology in high-carbon solid wastes exhibits significant differences. The carbon in coal-oil co-processing residues consists of cross-linked macromolecular lamellar stacking structures composed of aromatic carbon, while the carbon derived from waste tires after carbonization forms a porous carbon material including hard carbon nanospheres. Compared to coal-oil co-processing residues, the residual carbon from waste tires possesses more abundant hierarchical micro/mesoporous structures and enriched active sites (as shown in FIG. 1A and FIG. 1). When coal-oil co-processing residues are used as the carbon source, the Si—C—O system primarily undergoes solid-stage high-temperature carbothermal reduction between silica and lamellar carbon, leading to the formation of SiC nanosheets. In contrast, when waste tires serve as the carbon source, silica in the Si—C—O system initially reacts with nanosphere porous carbon to generate SiO and CO. Subsequently, SiO₂ and SiO further react with CO via gas-solid/gas-gas chemical vapor deposition (CVD), resulting in the formation of SiC nanowires (as detailed in FIG. 2 and FIG. 3A to FIG. 3H).

SiC nanowires and nanosheets/blocks demonstrate significant advantages across diverse applications owing to their unique structural and functional characteristics. SiC nanowires, with their high specific surface area and linear architecture, offer enlarged active surfaces that enhance surface reactivity, making them exceptional candidates for catalyst supports, adsorbents, and sensors. The continuous one-dimensional structure of SiC nanowires establishes efficient conductive pathways, substantially reducing resistivity and enabling superior electrical performance in electronic devices and electrode materials. Additionally, their inherent mechanical strength and flexibility render them highly suitable for composites and flexible electronics. In energy storage systems, the high specific capacity of SiC nanowires positions them as ideal electrode materials for lithium-ion batteries and supercapacitors.

In the present disclosure, a preparation may process of the pyrolyzed and carbonized waste tire includes subjecting a waste tire to pyrolysis and carbonization at a temperature of 500° C. to 700° C.; where the pyrolysis and carbonization may specifically be conducted at 550° C., 600° C., or 650° C.

In the present disclosure, the high-carbon solid waste may be subjected to crushing, ball-milling, and sieving in sequence before use.

In the present disclosure, the high-carbon solid waste may have a particle size of not greater than 0.2 mm, specifically 0.2 mm, 0.17 mm, 0.15 mm, 0.12 mm, 0.1 mm, 0.07 mm, 0.05 mm, or 0.01 mm.

In the present disclosure, a molar ratio of carbon in the high-carbon solid waste to silicon in the coal gangue silicon slag are in a range of (2-4):1, specifically 2:1, 2.4:1, 2.7:1, 3:1, 3.2:1, 3.5:1, 3.7:1, or 4:1. The aforementioned molar ratio of raw materials according to the present disclosure achieves enhanced reaction efficiency and product purity, enables precise control over the composition, morphology, and particle size of the product, and reduces energy consumption and production costs. Furthermore, the aforementioned molar ratio results in improving material performance and streamlining post-processing steps.

In the present disclosure, the first mixing could be ball milling mixing; the ball milling mixing is conducted at a rotational speed of 60% to 80%, specifically 65% or 75% for 1 min to 5 min, specifically 3 min; the ball milling mixing could be completed in a ball mill. The reaction raw materials could be fully mixed by ball milling.

In the present disclosure, the carbothermal reduction could be conducted in a protective atmosphere; the protective atmosphere could be provided by an inert gas or nitrogen; the inert gas could be argon; the carbothermal reduction could be completed in a high-temperature tubular furnace; the carbothermal reduction could include a heating stage and a holding stage. SiC is prepared through the carbothermal reduction.

In the present disclosure, in the heating stage, a heating rate is 5° C./min to 10° C./min, specifically 5° C./min, 6° C./min, 7° C./min, 8° C./min, 9° C./min, or 10° C./min.

In the present disclosure, the holding stage may be conducted at a temperature of 1,300° C. to 1,600° C., specifically 1,300° C., 1,350° C., 1,400° C., 1,450° C., 1,500° C., 1,550° C., or 1,600° C.; the holding stage may be conducted for 1 h to 5 h, specifically 1 h, 2 h, 3 h, 4 h, or 5 h.

In the present disclosure, the roasting may be conducted at a temperature of 500° C. to 1,000° C., specifically 700° C. or 800° C.; the roasting may be conducted for 1 h to 4 h, specifically 2 h or 3 h. Unreacted carbon residue is removed by the roasting.

In the present disclosure, a mass ratio of an acid for the acid pickling to a product of the roasting is in a range of (5-10):1, specifically 7:1; the acid for the acid pickling could be an HCl—HF mixed acid; and the acid pickling could be conducted at 30° C. for 12 h.

In some embodiments of the present disclosure, the method further includes after the acid pickling is completed, subjecting an obtained acid pickling product to washing and drying in sequence.

In the present disclosure, a reagent for the washing may include one or more of hydrochloric acid, nitric acid, and hydrofluoric acid; and the washing may be conducted not less than 3 times, specifically 3 times, 5 times, or 7 times, until an obtained washing solution becomes neutral.

In the present disclosure, the drying may be conducted at a temperature of 70° C. to 100° C., specifically 85° C. or 95° C. for 1 h to 24 h, specifically 12 h or 16 h.

Compared to conventional industrial SiC, the SiC nanomaterial synthesized via the method according to the present disclosure offers multifaceted advantages: such as enhanced specific surface area, which improves reaction activity and adsorption capacity; superior electrical performance with higher resistivity, making them suitable for high-frequency and high-power devices; eco-friendly and cost-effective production by utilizing the coal gangue, waste tire, and coal-oil co-processing residue as raw materials, reducing manufacturing costs while achieving waste valorization; nanostructure-driven performance that surpasses legacy SiC in electrical and optical properties, enabling broader application potential across advanced technologies. Moreover, SiC nanomaterials with different morphologies have significant differences in bandgap, specific capacity, and resistivity, thus exhibiting different excellent performances in different application scenarios. The nanosheet and nanowire SiC materials exhibit unique performance advantages due to their specialized microstructures and nano-size effects, demonstrating significant application potential in energy storage, field emission, and electromagnetic wave absorption devices. (i) The nanosheet and nanowire SiC materials exhibit unique performance advantages due to their specialized microstructures and nano-size effects, demonstrating significant application potential in energy storage, field emission, and electromagnetic wave absorption devices. The SiC nanomaterial prepared by the present disclosure feature a wider bandgap, enhancing stability and reliability under extreme conditions (e.g., high temperature/pressure) by suppressing leakage currents and reducing energy loss-critical for aerospace, defense systems (e.g., satellites, missiles), and 5G base stations to improve power amplifier efficiency and signal integrity. (ii) Specific capacity advantage and application scenarios: the excellent specific capacity characteristics of the prepared SiC nanomaterial give them significant advantages in energy storage. Improved specific capacity means more electrical energy can be stored within the same volume or weight, which holds great importance for high energy-density applications such as new energy vehicles and smart grids. In new energy vehicles, batteries using this SiC material can achieve extended driving ranges, faster charging speeds, improved cycle life, and reduced operational costs. In smart grids, it could be applied in energy storage systems to effectively balance grid loads while enhancing grid stability and reliability. (iii) Resistivity advantage and application scenarios: higher resistivity helps reduce leakage currents during device operation, improving insulation performance and stability.

In power electronics fields such as high-voltage DC transmission equipment and industrial frequency converters, the SiC nanomaterial developed in the present disclosure could decrease energy loss, improve conversion efficiency, reduce cooling system requirements, and enable device miniaturization and lightweight design. In microelectronics, their high resistivity characteristics facilitate the manufacturing of high-performance devices like insulated gate bipolar transistors (IGBTs), enhancing operational speed and stability of electronic equipment, making them suitable for power management and signal processing components in computers, smartphones, and other electronic products.

In order to further illustrate the present disclosure, the technical solutions provided by the present disclosure are described in detail below in conjunction with accompanying drawings and examples, but these examples should not be understood as limiting the scope of the present disclosure.

### Example 1 Using Coal-Oil Co-Processing Residue as Carbon Source

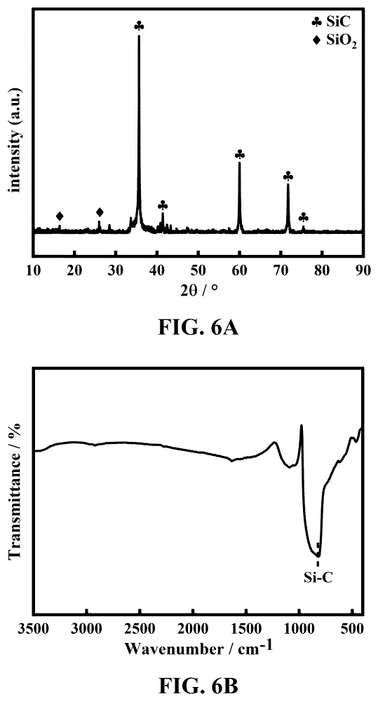

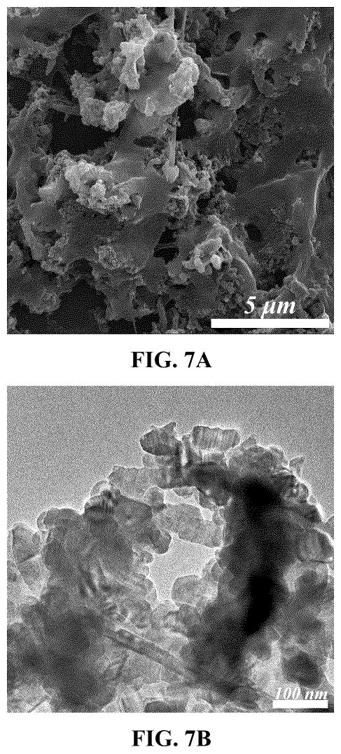

(1) Coal gangue and a coal-oil co-processing residue were crushed to not greater than 0.2 mm. An obtained coal gangue powder was evenly spread in a corundum crucible and subjected to high-temperature activation for 2 h in a muffle furnace by heating to 800° C. at a heating rate of 5° C./min. An obtained activated coal gangue powder was mixed with hydrochloric acid having a concentration of 20% at a mass-to-volume ratio of 1 g:5 mL. A resulting mixture was placed in an oil bath magnetic stirrer, and subjected to acid leaching at 120° C. for 24 h, then washing repeatedly until silicon slag was neutral, and then drying to obtain a coal gangue silicon slag with a silicon oxide content of >95%.
(2) The coal gangue silicon slag was mixed with the coal-oil co-processing residue at a C: Si molar ratio of 3:1 and subjected to ball milling for 5 min. An obtained system was then loaded into a high-temperature tubular resistance furnace, and heated to 1,600° C. at a heating rate of 10° C./min under nitrogen (N₂) protection atmosphere and held at the 1,600° C. for 4 h. After natural cooling to room temperature, an obtained product was transferred to the muffle furnace, and heated to 700° C. at a heating rate of 5° C./min and held at the 700° C. for 3 h. After natural cooling to room temperature, an obtained cooled material was subjected to mixing with HCl—HF solution having a concentration of 20% at a mass-to-volume ratio of 1 g:10 mL at 30° C. for 12 h. An obtained mixture was subjected to repeatedly washing until neutral pH was achieved, and then drying to obtain an SiC nanomaterial with a purity of 98.92%. The characterization results are presented in FIG. 6A, FIG. 6B, FIG. 7A, and FIG. 7B.

It can be seen from FIG. 6A, FIG. 6B, FIG. 7A and FIG. 7B that the structural characterization results reveals that the XRD and FT-IR patterns confirms the coexistence of SiC and SiO₂ phases in the synthesized material, and it can be seen from the SEM image that the coal gangue-derived SiC nanomaterial exhibits distinctive lamellar morphology. These plate-like structures are found to interstack and intertwine, forming irregular porous configurations with significant dimensional variations and abundant interstitial voids and cavities, contributing to an enlarged specific surface area. TEM image shows higher resolution visualization of the nanostructural details. Although displaying irregular edges, the flake-like morphological features are remarkably significant, and partial aggregation and interconnection between these flake-like particles were observed, forming complex agglomerates that further validates the unique flake-like morphological features of the SiC nanomaterial of the present disclosure.

### Example 2 Changing the Silicon-to-Carbon Ratio to Achieve Carbon Excess

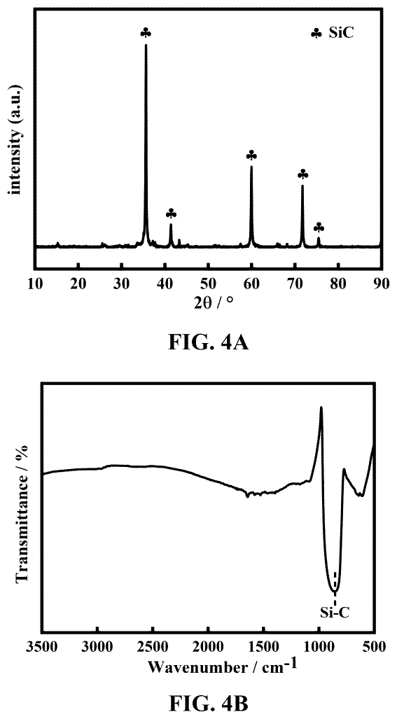

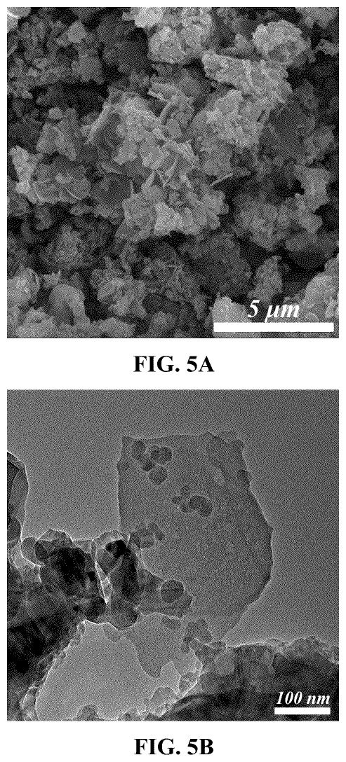

(1) Coal gangue and a coal-oil co-processing residue were crushed to not greater than 0.2 mm. An obtained coal gangue powder was evenly spread in a corundum crucible and subjected to high-temperature activation for 2 h in a muffle furnace by heating to 800° C. at a heating rate of 5° C./min. An obtained activated coal gangue powder was mixed with hydrochloric acid having a concentration of 20% at a mass-to-volume ratio of 1 g:5 mL. A resulting mixture was placed in an oil bath magnetic stirrer, and subjected to acid leaching at 120° C. for 24 h, then washing repeatedly until silicon slag was neutral, and then drying to obtain a coal gangue silicon slag with a silicon oxide content of >95%.
(2) The coal gangue silicon slag was mixed with the coal-oil co-processing residue at a C: Si molar ratio of 4:1 and subjected to ball milling for 5 min. An obtained system was then loaded into a high-temperature tubular resistance furnace, and heated to 1,600° C. at a heating rate of 10° C./min under nitrogen (N₂) protection atmosphere and held at the 1,600° C. for 4 h. After natural cooling to room temperature, an obtained product was transferred to the muffle furnace, and heated to 700° C. at a heating rate of 5° C./min and held at the 700° C. for 3 h. After natural cooling to room temperature, an obtained cooled material was subjected to mixing with HCl—HF solution having a concentration of 20% at a mass-to-volume ratio of 1 g:10 mL at 30° C. for 12 h. An obtained mixture was subjected to repeatedly washing until neutral pH was achieved, and then drying to obtain an SiC nanomaterial with a purity of 99.18%. The characterization results are presented in FIG. 4A, FIG. 4B, FIG. 5A and FIG. 5B.

FIG. 4A, FIG. 4B, FIG. 5A and FIG. 5B illustrate the characterization results of the SiC nanomaterial synthesized after carbon excess. The XRD pattern (FIG. 4A) reveals characteristic peaks corresponding to SiC, confirming the presence of SiC phase. FT-IR spectrum (FIG. 4B) exhibits distinct Si—C absorption peaks at specific wavenumbers, verifying the existence of Si—C bonds. SEM image (FIG. 5A) demonstrates an irregular flake-like and blocky morphology with interlocked structures and particles attached on the surface. TEM image (FIG. 5B) at nano-scale reveals aggregated irregular flakes/blocks forming large agglomerates with indistinct boundaries. Comparative analysis with Example 1 indicates that carbon excess significantly modified material characteristics, including pore structure, particle morphology, and agglomeration patterns.

### Example 3 Using Waste Tire as Carbon Source

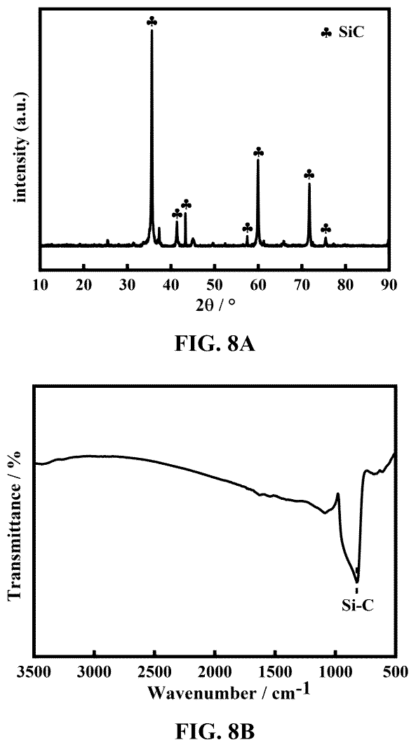

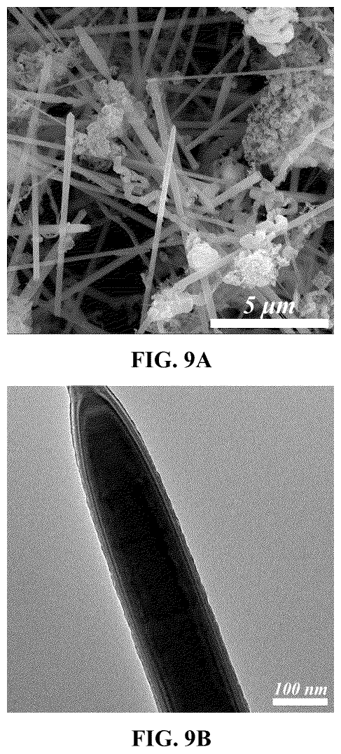

(1) Coal gangue and waste tire were crushed to not greater than 0.2 mm. An obtained coal gangue powder was evenly spread in a corundum crucible and subjected to high-temperature activation for 2 h in a muffle furnace by heating to 800° C. at a heating rate of 5° C./min. An obtained activated coal gangue powder was mixed with hydrochloric acid having a concentration of 20% at a mass-to-volume ratio of 1 g:5 mL. A resulting mixture was placed in an oil bath magnetic stirrer, and subjected to acid leaching at 120° C. for 24 h, then washing repeatedly until silicon slag was neutral, and then drying to obtain a coal gangue silicon slag with a silicon oxide content of >95%.
(2) A resulting crushed waste tire was placed in a high-temperature tubular resistance furnace and heated to 700° C. at 5° C./min in a protective gas (N₂) atmosphere. A resulting product was subjected high-temperature pyrolysis for 10 min, and then cooling to room temperature to obtain a carbonized waste tire with a fixed carbon content of 78.84 wt %.
(3) The coal gangue silicon slag was mixed with the carbonized waste tire at a C:Si molar ratio of 3.5:1 and subjected to ball milling for 5 min. An obtained system was then loaded into a high-temperature tubular resistance furnace, and heated to 1,600° C. at a heating rate of 10° C./min under nitrogen (N₂) protection atmosphere and held at the 1,600° C. for 4 h. After natural cooling to room temperature, an obtained product was transferred to the muffle furnace, and heated to 700° C. at a heating rate of 5° C./min and held at the 700° C. for 3 h. After natural cooling to room temperature, an obtained cooled material was subjected to mixing with HCl—HF solution having a concentration of 20% at a mass-to-volume ratio of 1 g:10 mL at 30° C. for 12 h. An obtained mixture was subjected to repeatedly washing until neutral pH was achieved, and then drying to obtain an SiC nanomaterial with a purity of 99.31%. The characterization results are presented in FIGS. 8A, FIG. 8B, FIG. 9A and FIG. 9B.

As shown in FIGS. 8A, FIG. 8B, FIG. 9A and FIG. 9B, the XRD pattern in FIG. 8A displays distinct characteristic peaks corresponding to SiC, confirming the presence of SiC stage. The FT-IR spectrum (FIG. 8B) exhibits prominent Si—C bond absorption peaks at specific wavenumbers, further verifying the existence of Si—C bonds. The SEM image (FIG. 9A) reveals well-defined fibrous structures with interwoven fibers of varying diameters and granular particles attached on the surface. The TEM image (FIG. 9B) clearly demonstrates the fibrous nanostructure at the nano-scale, featuring regular morphology and sharp boundaries. These characterization results collectively confirms the successful synthesis of SiC nanofibers from coal gangue and waste tire.

### Example 4 Changing Reaction Time

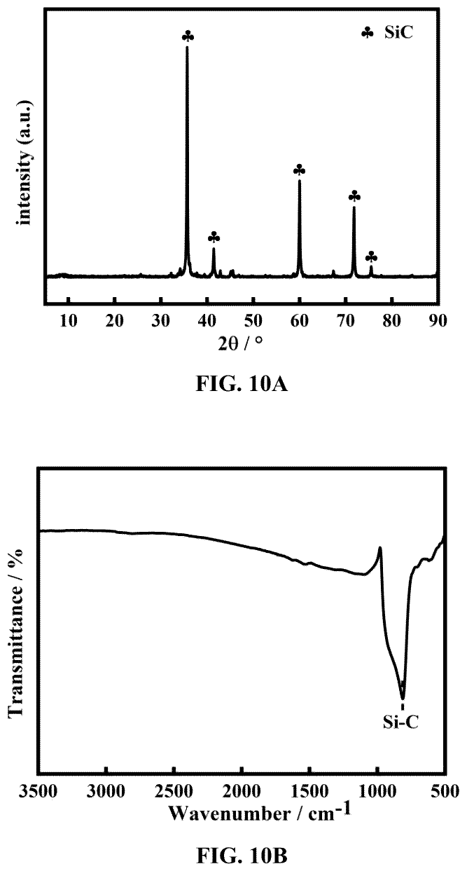

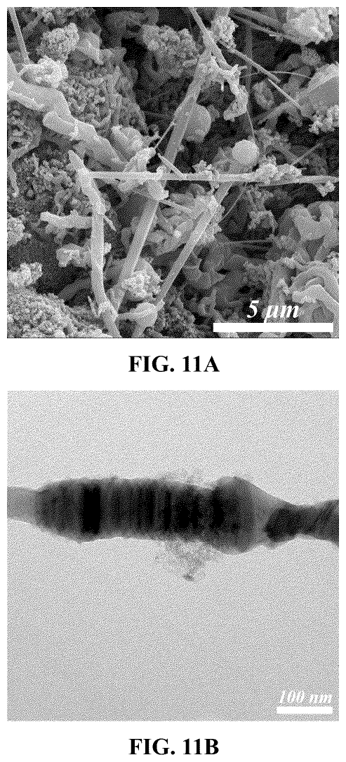

(1) Coal gangue and waste tire were crushed to not greater than 0.2 mm. An obtained coal gangue powder was evenly spread in a corundum crucible and subjected to high-temperature activation for 2 h in a muffle furnace by heating to 800° C. at a heating rate of 5° C./min. An obtained activated coal gangue powder was mixed with hydrochloric acid having a concentration of 20% at a mass-to-volume ratio of 1 g:5 mL. A resulting mixture was placed in an oil bath magnetic stirrer, and subjected to acid leaching at 120° C. for 24 h, then washing repeatedly until silicon slag was neutral, and then drying to obtain a coal gangue silicon slag with a silicon oxide content of >95%.
(2) A resulting crushed waste tire was placed in a high-temperature tubular resistance furnace and heated to 700° C. at 5° C./min in a protective gas (N₂) atmosphere. A resulting product was subjected high-temperature pyrolysis for 10 min, and then cooling to room temperature to obtain a carbonized waste tire with a fixed carbon content of 78.84 wt %.
(3) The coal gangue silicon slag was mixed with the carbonized waste tire at a C:Si molar ratio of 3.5:1 and subjected to ball milling for 5 min. An obtained system was then loaded into a high-temperature tubular resistance furnace, and heated to 1,600° C. at a heating rate of 10° C./min under nitrogen (N₂) protection atmosphere and held at the 1,600° C. for 3 h. After natural cooling to room temperature, an obtained product was transferred to the muffle furnace, and heated to 700° C. at a heating rate of 5° C./min and held at the 700° C. for 3 h. After natural cooling to room temperature, an obtained cooled material was subjected to mixing with HCl—HF solution having a concentration of 20% at a mass-to-volume ratio of 1 g:10 mL at 30° C. for 12 h. An obtained mixture was subjected to repeatedly washing until neutral pH was achieved, and then drying to obtain an SiC nanomaterial with a purity of 99.12%. The characterization results are presented in FIG. 10A, FIG. 10B, FIG. 11A and FIG. 11B.

Based on FIG. 10A, FIG. 10B, FIG. 11A and FIG. 11B, it was observed that the XRD pattern and FT-IR spectrum exhibit characteristic diffraction peaks of SiC in terms of peak positions and intensities, similar to the results obtained after 4 h of holding time in Example 3, indicating that the SiC stage was successfully synthesized even under the 3-h holding condition at the 1600° C. It can be seen from the SEM images that the material displays a fibrous structure accompanied by some particulate or block-like substances. Compared with the SEM and TEM images of the 4-h holding samples, variations were noted in fiber morphology and distribution, such as differences in fiber thickness, length uniformity, and potentially the degree of interweaving between fibers. These structural discrepancies are attributed to the shorter holding time, which affects the material's growth and agglomeration processes. Overall, the SiC materials prepared by 3-h and 4-h holding times show nearly identical stage compositions (both successfully synthesizing SiC), but obvious distinct differences in microstructure, demonstrating that holding duration significantly influences the micromorphology and internal structure of SiC material.

### Comparative Example 1

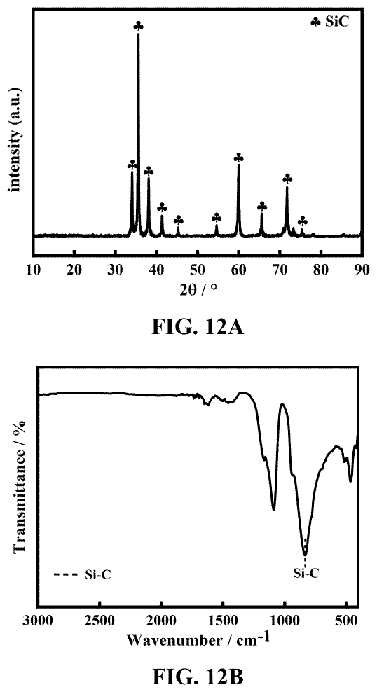

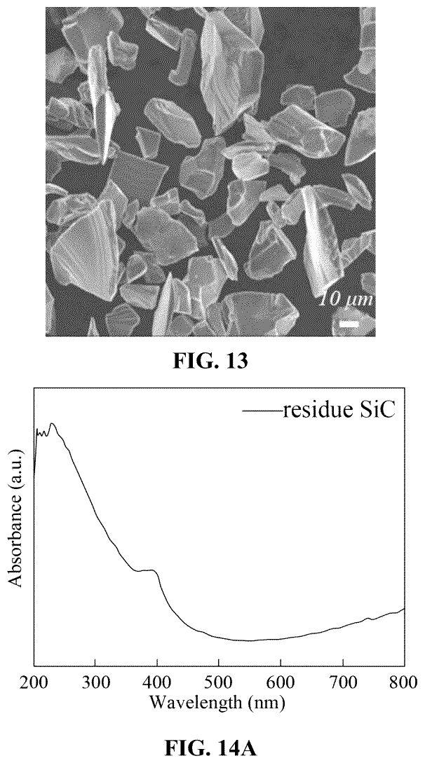

This comparative example was a commercially available SiC product (using quartz sand and petroleum coke as raw materials), and its XRD pattern and FTIR diffraction spectrum are shown in FIG. 12A and FIG. 12B, and its morphology is shown in FIG. 13.

As shown in FIG. 12A, FIG. 12B and FIG. 13, the XRD pattern and FT-IR spectrum confirm that the commercial SiC product indeed possess the crystalline structure of SiC, demonstrating essentially identical patterns to those of the SiC prepared in the present disclosure. SEM image reveals that commercial-grade SiC displays irregular flake-like or blocky morphologies with varying particle sizes that were randomly aggregated. In contrast, the SiC synthesized in the present disclosure exhibits more diverse microstructures, which could endow the material with unique properties such as enhanced specific surface area and complex interfacial characteristics, which is advantageous for applications in adsorption and catalysis. The well-developed porous structure facilitates efficient gas/liquid adsorption and diffusion, showing potential advantages in energy storage and separation technologies. Moreover, the method allows flexible control over particle morphology and aggregation patterns through adjusting preparation conditions. Particularly, the distinctive nanowire-structured SiC morphology create expanded possibilities for high-performance applications, including high-strength composite materials and thermal management in electronic devices.

### Test Example 1

The performances of the SiC nanomaterials prepared in Examples 1 to 4 and the SiC material from Comparative Example 1 were characterized through standardized testing protocols. Electrical properties were evaluated using the optical absorption coefficient method; specific capacity was measured via cyclic voltammetry; and resistivity was determined by the van der Pauw method (Physical Property Measurement System, PPMS). The test results are shown in Table 3.

TABLE 3
Performance test results of SiC materials in
Examples 1 to 4 and Comparative Example 1

| | | | Specific | |
|---|---|---|---|---|
| | | Bandgap, | capacity, | Resistivity, |
| Example | Morphology | eV | mAh/g | Ω · cm |
| Example 1 | Nanosheet | 2.45 | 367.54 | 2456.81 |
| Example 2 | Nanosheet | 2.51 | 352.62 | 2428.71 |
| Example 3 | Nanowire | 2.6 | 285.89 | 1195.58 |
| Example 4 | Nanowire | 2.62 | 271.33 | 1207.86 |
| Comparative | Micron-sized | 2.23 | 157 | 761.89 |
| Example 1 | block | | | |

As shown in Table 3, comparative analysis reveals that the nanosheet-like and nanowire-like SiC materials prepared in the present disclosure exhibit distinct differences from their micron-sized bulk counterparts in key properties such as bandgap, specific capacity, and resistivity. Notably, the nanostructured materials exhibit superior performance in certain metrics, providing valuable insights for the selection and optimization of SiC materials in diverse application scenarios.

From the perspective of electrical resistivity, the nanowire-structured SiC prepared in the present disclosure demonstrates a resistivity of 1,195.58 Ω·cm, which is lower than that of the nanosheet/bulk-structured SiC (2,456.81 Ω·cm), yet both significantly exceed the commercial-grade material (761.89 Ω·cm). This elevates resistivity conferred distinct advantages in specific high-resistance applications. Notably, the high resistivity enables exceptional performance as insulating materials, where it effectively blocks current flow and ensures safe equipment operation, making these materials particularly suitable for manufacturing high-voltage insulators and cable insulation layers. In specialized electronic components such as high-precision resistors and specific transistor types requiring precise current control, the superior resistivity of the synthesized SiC nanomaterial meets stringent operational demands while ensuring device stability and reliability. Furthermore, in the biomedical field, the high-resistance characteristic showed potential for bioelectrode fabrication and neural stimulator development, effectively minimizing electrical damage to surrounding tissues. Additionally, the nano-scaled SiC demonstrates applicability in high-temperature heating elements and specialized thermal devices, addressing the critical need for high-performance materials in aerospace, defense, and other advanced technological sectors.

Building upon the preceding analysis, the bandgap, a critical parameter for semiconductor materials, was systematically evaluated. The nanowire-structured SiC synthesized exhibits a bandgap of 2.6 eV, surpassing both the nanosheet/bulk-structured SiC (2.45 eV) and commercial-grade material (2.23 eV). This bandgap enlargement typically indicates enhanced performance in optoelectronic applications, particularly in photocatalysis, photodetection, and solar cell technologies. The expanded bandgap enables broader spectral photon absorption, thereby improving photoelectric conversion efficiency. Furthermore, the increased bandgap contributes to superior thermal and chemical stability, allowing the material to maintain robust performance under elevated temperatures or harsh operating conditions.

Regarding specific capacity, the SiC nanomaterials prepared in the present disclosure demonstrate substantial advancements: the nanowire-structured SiC achieves 285.89 mAh/g, while the nanosheet/bulk-structured SiC reaches 367.54 mAh/g, both markedly exceeding the commercial-grade material (157 mAh/g). This significant enhancement in specific capacity underscores the material's considerable potential for electrochemical energy storage, particularly in lithium-ion batteries and supercapacitors. The superior specific capacity of nanowire-structured SiC is attributed to its unique one-dimensional morphology, which provides an enlarged specific surface area and abundant active sites, thereby enhancing electrochemical reactivity. In contrast, the higher capacity of nanosheet/bulk-structured SiC stems from improved structural integrity during charge-discharge cycles, which effectively maintains morphological stability and optimized cycling performance.

In summary, the nanowire-structured and nanosheet/bulk-structured SiC materials prepared according to the present disclosure exhibit superior performance over commercial-grade counterparts across critical metrics including resistivity, bandgap, and specific capacity. With their enhanced bandgap, exceptional specific capacity, and elevated resistivity, these materials exhibit expanded application potential in diverse fields such as aerospace, defense systems, 5G telecommunications, new energy vehicles, smart grids, and power electronics. These advantages prove capable of addressing modern industrial demands for high-performance, energy-efficient, reliable, and miniaturized materials, while driving technological advancement and innovation across these critical sectors.

### Test Example 2

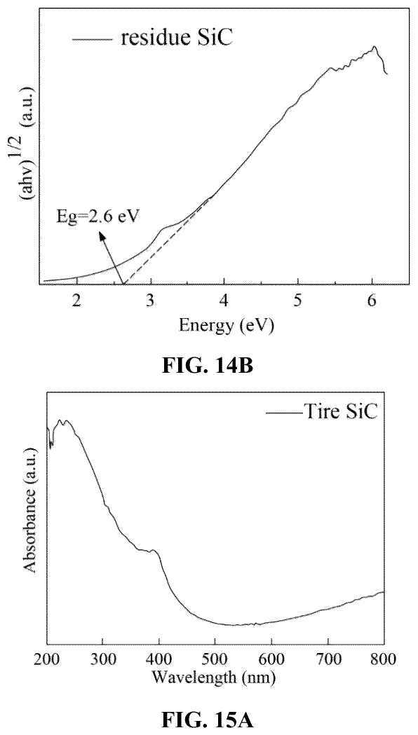

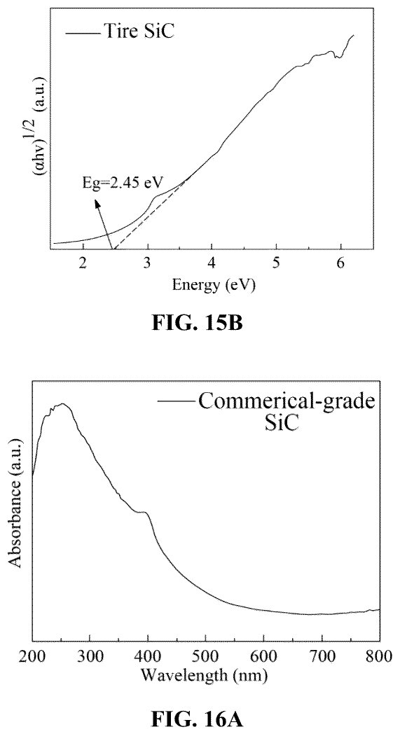

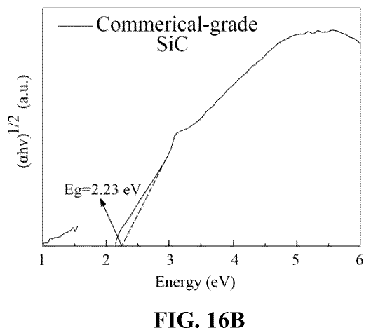

UV-Vis diffuse reflectance spectroscopy and bandgap determination were conducted on the SiC materials from Example 1, Example 3, and Comparative Example 1. The testing protocol involved: setting a slit width of 20 nm; using standard barium sulfate as the reference; measuring light absorption intensity across the 200-800 nm wavelength range using a Shimadzu UV-2550 UV-Vis diffuse reflectance spectrophotometer. Reflectance spectra were converted to absorbance via the Kubelka-Munk (K-M) transformation method. Results were illustrated in FIG. 14A, FIG. 14B, FIG. 15A, FIG. 15B, FIG. 16A and FIG. 16B.

As evidenced by the UV-Vis spectra in FIG. 14A, FIG. 14B, FIG. 15A, FIG. 15B, FIG. 16A and FIG. 16B, all three materials—residue-derived SiC (from coal-oil co-processing residue and coal gangue), tire-derived SiC (from waste tires and coal gangue), and commercial-grade SiC—exhibit strong absorption in the short-wavelength region, with absorption intensity decreasing as wavelength increased. However, distinct variations in absorption peak shapes and positions are observed, reflecting differences in their microstructural characteristics such as crystal defects and impurity concentrations. Bandgap energy measurements reveal values of 2.6 eV for residue-derived SiC, 2.45 eV for tire-derived SiC, and 2.23 eV for commercial-grade SiC. Since the bandgap energy directly govern the electrical and optical properties of SiC, the larger bandgap values of the residue- and tire-derived materials indicate superior insulating capabilities and higher breakdown field strength potential compared to the commercial counterpart. These findings collectively demonstrate the enhanced electrical performance-related characteristics of the SiC nanomaterial synthesized in the present disclosure over conventional commercial SiC.

Based on the above examples, the method according to the present disclosure achieves complementary high-value utilization of solid wastes such as coal gangue and high-carbon solid waste, significantly reducing the production cost of SiC while addressing the environmental and safety challenges caused by solid waste disposal. Moreover, the SiC nanomaterial with high purity and nano-scale dimension is successfully synthesized, demonstrating broad application prospects in advanced industrial fields demonstrating broad.

Although the present disclosure is described in detail in conjunction with the foregoing embodiments, they are only a part of, not all of, the embodiments of the present disclosure. Other embodiments could be obtained based on these examples without creative efforts, and all of these embodiments shall fall within the scope of the present disclosure.

What is claimed is:

1. A method for preparing a silicon carbide (SiC) nanomaterial using a solid waste, comprising the following steps:
(1) subjecting coal gangue to activation and acid leaching in sequence to obtain a coal gangue silicon slag; and
(2) mixing the coal gangue silicon slag and a high-carbon solid waste, and subjecting a resulting mixture to carbothermal reduction, and then subjecting a resulting reduction product to roasting and acid pickling in sequence to obtain the SiC nanomaterial;
wherein the high-carbon solid waste has a carbon content of 70 wt % to 80 wt %; the coal gangue has a purity of not less than 95%; and the SiC nanomaterial has a bandgap of not less than 2.45 eV, a specific capacity of not less than 270 mAh/g, and a resistivity of not less than 1,190 Ω·cm.

2. The method of claim 1, wherein the carbothermal reduction is conducted in a protective atmosphere;
the carbothermal reduction comprises a heating stage and a holding stage;
in the heating stage, a heating rate is 5° C./min to 10° C./min; and
in the holding stage, a temperature of 1,300° C. to 1,600° C. is held for 1 h to 5 h.

3. The method of claim 1, wherein the roasting is conducted at a temperature of 500° C. to 1,000° C. for 1 h to 4 h.

4. The method according to claim 1, wherein the activation is conducted at a temperature of 500° C. to 1,000° C. for 60 min to 240 min.

5. The method of claim 1, wherein the method further comprises heating the coal gangue before the activation; and
the heating is conducted at a heating rate of 5° C./min to 10° C./min.

6. The method of claim 4, wherein the method further comprises heating the coal gangue before the activation; and
the heating is conducted at a heating rate of 5° C./min to 10° C./min.

7. The method of claim 1, wherein the acid leaching is conducted in an acid solution at a temperature of 80° C. to 150° C. for 1 h to 24 h;
the acid leaching is conducted under stirring; and
a ratio of a volume of the acid solution to a mass of the coal gangue is in a range of 1 mL: 1 g to 10 mL: 1 g.

8. The method of claim 1, wherein the high-carbon solid waste is one or more selected from the group consisting of a coal-oil co-processing residue, and a pyrolyzed and carbonized waste tire.

9. The method of claim 8, wherein the pyrolyzed and carbonized waste tire is prepared by a process comprising subjecting a waste tire to pyrolysis and carbonization at a temperature of 500° C. to 700° C.

10. The method of claim 1, wherein a molar ratio of carbon in the high-carbon solid waste to silicon in the coal gangue silicon slag is in a range of 2:1 to 4:1.

11. The method of claim 8, wherein a molar ratio of carbon in the high-carbon solid waste to silicon in the coal gangue silicon slag is in a range of 2:1 to 4:1.

12. The method of claim 1, wherein the mixing of the coal gangue silicon slag and the high-carbon solid waste is conducted by ball milling mixing, and the ball milling mixing is conducted at a rotational speed of 60% to 80% for 1 minute to 5 minutes.

13. The method of claim 8, wherein the mixing of the coal gangue silicon slag and the high-carbon solid waste is conducted by ball milling mixing, and the ball milling mixing is conducted at a rotational speed of 60% to 80% for 1 minute to 5 minutes.
